(19) United States
(12) Patent Application Publication
(10) Pub. No.: US 2010/0040332 A1
(43) Pub. Date: Feb. 18, 2010

(54) MULTI-CONTACT CONNECTOR ELEMENT

(75) Inventors: Bernard VAN DEN MEERSSCHAUT, Nazelles Negron (FR); Marnix VAN DER MEE, Montlouis Sur Loire (FR)

Correspondence Address: Oliff & Berridge, PLC, P.O. Box 320850, Alexandria, VA, 22320-4850, US

(73) Assignee: RADIALL, Rosny Sous Bois (FR)

(21) Appl. No.: 12/539,928

(22) Filed: Aug. 12, 2009

(30) Foreign Application Priority Data
Aug. 12, 2008 (FR) 08 55534

(51) Int. Cl. G02B 6/36; H01R 24/00; H01R 13/648; H01R 43/20

(52) U.S. Cl. 385/75; 439/660; 439/607.01; 29/747; 385/55

(57) ABSTRACT

The present invention concerns a multi-contact connector element comprising at least one of electrical and optical contacts, a case and an insulating insert comprising more than two cells for receiving contacts, wherein the case is made from an electrically nonconductive material, and wherein the connector element comprises an envelope made from an electrically conductive material, housed inside the case and defining a housing for the insert.

The present invention concerns a multi-contact connector element, comprising electrical contacts and/or optical contacts.

The invention more particularly concerns connectors for aeronautics, in particular connectors for the connection of electrical apparatuses in aircrafts.

It is known, in order to produce such connector elements, to use connector cases molded in a composite material, metalize the cases and integrate mechanical devices therein in order to achieve maintenance of the insulators supporting the electrical or optical contacts.

Nevertheless, the metallization operation of a composite material can be delicate and relatively costly. Moreover, obtaining a constant metal deposition thickness during the metallization operation often depends on a number of parameters which are difficult to control. Lastly, it may be difficult to perform the metallization operation with certain composite materials, which limits the choice of starting composite materials for producing the connector case.

Moreover, maintaining the insulator supporting the contacts in the case may require the use of additional parts mounted inside the case, which can also cause an increase in the manufacturing cost of the connector element.

It is also known, in order to ensure maintenance of the insulator supporting the contacts in the connector element case, to equip the case and/or the insulators supporting the contacts with integrated clips molded in a composite material. Nevertheless, such solutions may not be satisfactory in that they make disassembly of the insulator delicate when it is in place in the case, for example.

The object of exemplary embodiments of the invention is to resolve the aforementioned drawbacks, in particular to make it possible to obtain a connector element providing sufficient protection against electromagnetic interference while ensuring the mechanical maintenance of the insulator supporting the contacts in the connector case. Exemplary embodiments of the invention provide a multi-contact connector element comprising:
at least one of electrical and optical contacts,
a case, and
an insulating insert comprising cells for receiving contacts,
   the case being made from in an electrically non-conductive material and the connector element comprising an envelope made from an electrically conductive material, housed inside the case and defining a housing for the insert.

The insulating insert may comprise a plurality of cells for receiving contacts, in particular more than two such cells. The insulating insert may have a parallepiped shape, extend along a longitudinal axis and have two opposite end faces that may be substantially planar.

The cells may be located on an end face of the insulating insert according to two dimensions.

At least one end face of the envelope may include a single opening for receiving the insulating insert.

The case may be made as a single piece, being, for example, different from a case constituted by two half-shells fastened together.

The connector element comprise, for example, a single envelope.

Exemplary embodiments of the invention make it possible in particular to obtain satisfactory protection against electromagnetic interference, without resorting, thanks to the integration of the electrically conductive envelope, to a metallization operation of the connector element case.

The envelope advantageously comprises at least one relief, in particular a lance, configured to cooperate with a maintenance element of the case, for example one or several retention tabs protruding into the housing arranged inside the case to receive the envelope, in order to permanently secure the envelope in the case.

In variation, the envelope advantageously comprises at least one relief, in particular a retention tab, arranged in order to cooperate with a maintenance element of the case in order to removably maintain the envelope in the case. The maintenance element of the case is for example a recess arranged on the inner surface of the case and defining a catching zone for the maintenance tab(s) of the envelope.

The envelope may comprise at least one relief, in particular a lance protruding in the housing designed to receive the insulating insert, configured to permanently secure the insulating insert in the housing. Said relief(s) may be carried by lateral faces of the envelope, said lateral faces being, for example, different from the top and bottom faces of the envelope. Said relief(s) may cooperate with relief(s) of a complementary type carried by lateral faces of the insert, said lateral faces of the insert being in particular different from the top and bottom faces of the insert.

In variation, the envelope comprises at least one relief, in particular an elastic tab protruding in the housing designed to receive the insulating insert, arranged in order to removably maintain the insulating insert in the housing.

The relief(s) of the envelope for maintaining or securing the envelope in the case and the relief(s) of the envelope for maintaining or securing the insulating insert in the housing may be carried by the same face of the envelope.

The connector element may lack a holding element configured to be fitted onto the insert and to maintain the electrical and/or optical contacts in the cells.

The connector element according to the invention can be of the male (plug) or female (socket) type.

In the case of the socket, the latter part is for example secured to a panel and the envelope comprises, at a first longitudinal end, ground connection means on the panel.

In the case of the plug, the latter part may comprise a shield cap mounted on the plug. The plug may be straight, being for example different from a connector of elbow type.

The envelope may comprise, at a first longitudinal end, ground connection means on the shield cap.

The envelope of the connector element may comprise a plurality of elastic tabs cooperating with the envelope of another connector element upon coupling of these two connector elements, said tabs making it possible for example to ensure the electrical continuity between the connector element cases by slight elastic deformation upon their coupling.

The envelope may be surrounded along a major part of its length by the case, when housed inside the case, for example more than 50%, better 70%, better 90% of its length.

These elastic tabs may be supported by the face of the envelope defining the bottom of the housing and/or by the upper face of the envelope.

The connector element may only include optical contacts. In a variant, the connector element only includes electrical contacts.

Other exemplary embodiments of the invention, provide a method for assembling a multi-contact connector element as defined above, in which:
the insulating insert supporting at least one of the electrical and optical contacts is introduced in the housing defined by the envelope,
the assembly formed by the envelope and the insert is introduced inside the connector element case, and
the ground connection means are folded toward their free end,

The method comprises, for example, the additional step of forming at least one lance on each longitudinal face of the envelope, when the insert is introduced into the housing defined by the envelope, in order to permanently secure the insulating insert in the housing.

The method comprises, for example, the additional step of forming, when the aforementioned assembly is housed in the case, at least one lance on each lateral face of the envelope, so as to permanently secure the envelope in the case.

Other advantages and characteristics of the invention will appear upon reading the following description of non-limiting examples of embodiments of the invention in reference to the appended drawing, in which:

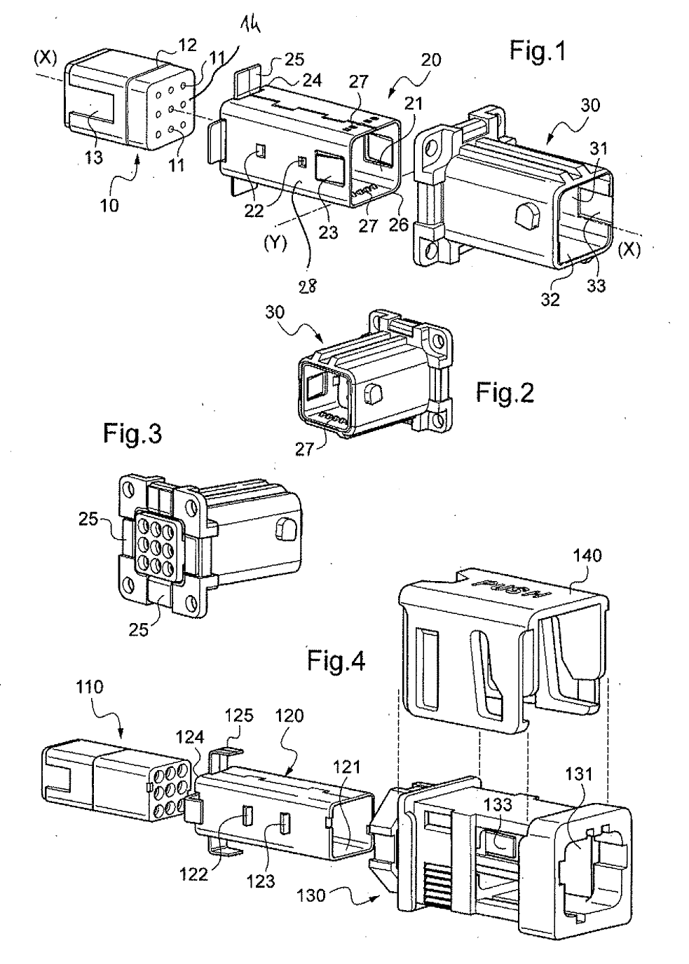

FIG. 1 is an exploded view of a panel socket according to the invention,

FIGS. 2 and 3 are front and rear views, respectively, of an assembled panel socket,

FIG. 4 is an exploded view of a plug for cable according to the invention,

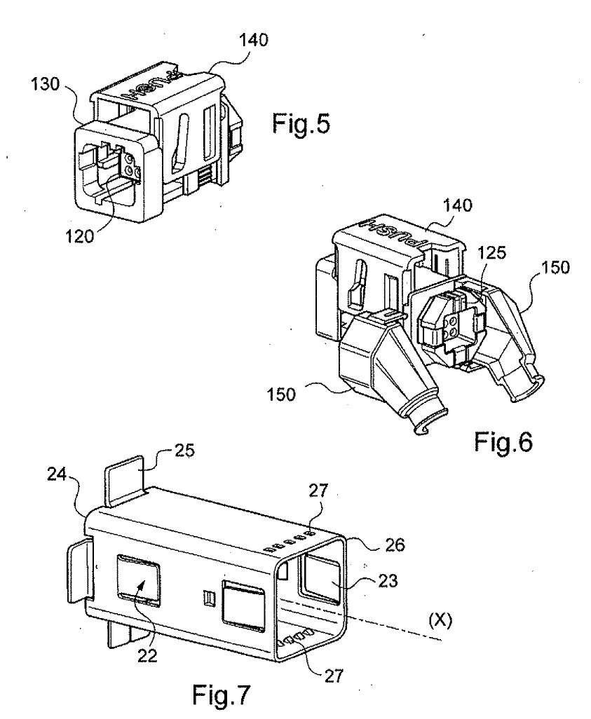

FIGS. 5 and 6 are front and rear views, respectively, of assembled plugs, and

FIG. 7 is an isolated view of another example of envelope according to the invention.

In FIG. 1 we have shown a panel socket globally designated 1, comprising an insulating insert globally designated 10, an envelope made from an elastically conductive material globally designated 20, and a case made from an electrically nonconductive material globally designated 30.

The insulating insert 10 may extend along a longitudinal axis X and include a plurality of cells 11, in particular more than two cells, supported by an end face 14 that may be substantially planar, said cells for receiving electrical and/or optical contacts. The cells are for example arranged according to two dimensions. In the embodiment described, the cells 11 form a grid having three rows and three columns. On its outer surface 12, the insulating insert comprises recesses 13, the role of which will be specified below.

The insulating insert is for example made in a thermoplastic material.

As one can see in FIGS. 2 and 3, this insulating insert 10 is designed to be received in a housing 21 arranged inside the envelope 20. The envelope is for example made in metal, for example in an alloy containing copper.

In the example described, the envelope 20 has a globally parallelepiped shape along the longitudinal axis X, but the invention is of course not limited to a particular envelope shape.

The envelope has, at a first longitudinal end 24, a plurality of tongues 25 extending perpendicular to the longitudinal axis X.

At a second longitudinal end 26, the envelope comprises a plurality of elastic tabs 27 arranged along an axis Y perpendicular to the axis X. In the described example, the elastic tabs 27 are supported by the face of the envelope defining the bottom of the housing 21 and by the upper face of the envelope. These tabs 27 make it possible, for example, to ensure the electrical continuity between the connector element cases through slight elastic deformation upon their coupling.

As one may see in FIG. 1, the envelope 20 comprises reliefs 22 and 23, the role of which will be specified below, said reliefs being supported by lateral faces 28 of the envelope 20 that are different from the top and bottom faces of the envelope.

In the example illustrated in FIG. 1, the envelope comprises, on each lateral face 28, two lances 22 protruding in the housing 21 designed to receive the insulating insert 10. These lances are for example made after the insulating insert has been introduced into the housing 21.

The invention is of course not limited to such an example. In the example illustrated in FIG. 7, the reliefs 22 protruding in the housing 21 are elastic tabs.

In the example illustrated in FIG. 1, the envelope comprises, on each lateral face, a retention tab 23 protruding toward the outside of the envelope 20.

In variation, the relief 23 protruding toward the outside of the envelope is a lance formed after the envelope 20 has been introduced into the case 30.

As one can see in FIGS. 1 to 3, the envelope 20 is designed to be received inside a housing 31 arranged inside the case 30.

The case is, for example, made from a composite material, for instance a polymer material chosen among PEEK (polyetheretherketone), PEI (polyetherimide) and PPS (phenylene polysulfide).

In the example described, the case 30 comprises recesses 33 on its inner surface 32 which defines the housing 31. In variation, the case comprises, on its inner surface 32, retention tabs protruding in the housing 31.

Upon assembly of the socket as shown in FIGS. 2 and 3, the reliefs 22 of the envelope 20 cooperate with the recess 13 in order to maintain the insulating insert 10 in the housing 21. Depending on the nature of the reliefs 22, the insert 10 is permanently secured in the housing 21 or removably maintained therein.

The reliefs 23 of the envelope cooperate with the recess 32 or the retention tabs of the case 30 in order to maintain the envelope in the housing 31.

Depending on the nature of the reliefs 23, the envelope 20 is permanently secured in the housing 31 or removably maintained therein.

As one can see in FIG. 3, the tongues 25 make it possible to ensure the ground connection of the socket 1 on the panel, which was not shown for clarity of the drawing.

In FIGS. 4 to 6, we have shown one example of application of the invention for the production of cable plugs, for example straight plugs.

As one can see in FIGS. 4 to 6, this plug, globally designated 100, comprises an insulating insert 110, an envelope 120 and a case 130 similar to those described in reference to FIGS. 1 to 3, as well as a locking cover 140 and two screening half-covers 150 arranged to be secured on the case 130.

In the example shown in FIG. 4, the reliefs 122 and 123 enabling maintenance of the insulating insert 110 in the housing 121 arranged in the envelope 120 and maintenance of the envelope 120 in the housing 131 arranged in the case 130, respectively, are lances formed during assembly, but it is not beyond the scope of the present invention for the reliefs 122 and 123 to be as described in reference to FIGS. 1 to 3 or FIG. 7.

In the example of FIG. 4, the envelope 120 is maintained inside the housing 131 via retention tabs 133, but it is not beyond the scope of the present invention for the inner surface 132 defined by the housing 131 to comprise recesses cooperating with the reliefs 123 in order to ensure maintenance of the envelope 120 in the housing 131.

The envelope 120 comprises, in the example of FIGS. 4 to 6, at a first longitudinal end 124, tongues 125, similar to those described in reference to FIGS. 1 to 3, these tongues 125 being designed to be folded toward their free end and making it possible to ensure the ground connection with the screening covers 150.

1. A multi-contact connector element comprising:
at least one of electrical and optical contacts,
a case, and
an insulating insert comprising more than two cells for receiving contacts, wherein the case is made from an electrically nonconductive material, and wherein the connector element comprises an envelope made from an electrically conductive material, housed inside the case and defining a housing for the insert.

2. The connector element according to claim 1 wherein the envelope comprises at least one relief configured to cooperate with a maintenance element of the case in order to permanently secure the envelope in the case.

3. The connector element according to claim 1, wherein the envelope comprises at least one relief arranged in order to cooperate with a maintenance element of the case configured to removably maintain the envelope in the case.

4. The connector element according to claim 1, wherein the envelope comprises at least one relief configured to permanently secure the insert in the housing arranged in the envelope.

5. The connector element according to claim 1, wherein the envelope comprises at least one relief configured to removably maintain the insert in the housing arranged in the envelope.

6. The connector element according to claim 1, wherein the envelope comprises, at a first longitudinal end arranged in a socket, ground connection means on a panel.

7. The connector element according to claim 1 arranged in a plug, wherein said plug comprises a screening cover.

8. The connector element according to claim 7, wherein the envelope comprises, at a first longitudinal end, ground connection means on the screening cover.

9. The connector element according to claim 1, wherein the envelope comprising a plurality of elastic tabs cooperating with the envelope of another connector element upon coupling of these two connector elements, said tabs being configured to ensure the electrical continuity between the connector element cases by slight elastic deformation upon their coupling.

10. A method for assembling a multi-contact connector element according to claim 6, in which:
the insulating insert supporting the at least one of electrical and optical contacts is introduced into the housing defined by the envelope,
the assembly formed by the envelope and the insulating insert is introduced inside the case of the connector element, and
the ground connection means are folded toward their free end.

11. The connector element of claim 1, wherein the case is made as a single piece.

12. The connector element of claim 1, wherein it comprises a single envelope.

13. The connector of claim 2, wherein the at least one relief for permanently securing the envelope in the case and the at least one relief for permanently securing the insert in the housing are carried by the same face of the envelope.

14. The connector of claim 3, wherein the at least one relief for removably maintaining the envelope in the case and the at least one relief for removably maintaining the insert in the housing are carried by the same face of the envelope.

15. The connector of claim 7, wherein the plug is straight.
